(19) United States
(12) Patent Application Publication
(10) Pub. No.: US 2023/0306183 A1
(43) Pub. Date: Sep. 28, 2023

(54) Dynamically Partitioning and Superseding Documents

(71) Applicant: Gavin Burke, Oceanside, CA (US)

(72) Inventor: Gavin Burke, Oceanside, CA (US)

(21) Appl. No.: 18/124,693

(22) Filed: Mar. 22, 2023

Related U.S. Application Data
(60) Provisional application No. 63/322,538, filed on Mar. 22, 2022.

(51) Int. Cl. G06F 40/103; G06F 40/166

(52) U.S. Cl. CPC G06F 40/103; G06F 40/166

(57) ABSTRACT

A memory includes a document-partitioning module with instructions executed by a processor to dynamically partition and supersede a plurality of subspaces nested in a document.

### CROSS REFERENCE TO RELATED APPLICATIONS

This application claims priority to a co-pending U.S. Provisional Application Serial No. 63/322,538 filed Mar. 22, 2022 entitled “Dynamically Partitioning and Superseding Machine-Readable Documents”, the entire contents of which are hereby incorporated by reference.

### TECHNICAL FIELD

This patent application relates generally to computation for manipulating documents.

### BACKGROUND

Digital documents typically consist of a mere single supersedable space or a plurality of supersedable subspaces which are static in size and/or number. Document structures and user interfaces consequently maintain empty, unuseful, or otherwise superfluous space.

### SUMMARY

Accordingly, an object of the present invention is to make traversing documents faster and easier.

The foregoing and other objects are achieved in a document-partitioning module with instructions executed by a processor to manipulate subspaces that are nested within a document in response to user input.

More particularly, a document nests a plurality of subspaces. The subspaces house information. The subspaces are dynamic in both size and number: the size and number of them mutate in response to changes in the size of the document. User-generated events in subspaces engender new information and revive old information in them.

### BRIEF DESCRIPTION OF THE DRAWINGS

FIGS. 1A-1D illustrate operations for manipulating subspaces nested in documents;

FIGS. 2A-2D illustrate manipulations of documents nesting subspaces;

FIGS. 3A-3D illustrate subspaces superseded with new information.

### DETAILED DESCRIPTION OF PREFERRED EMBODIMENTS

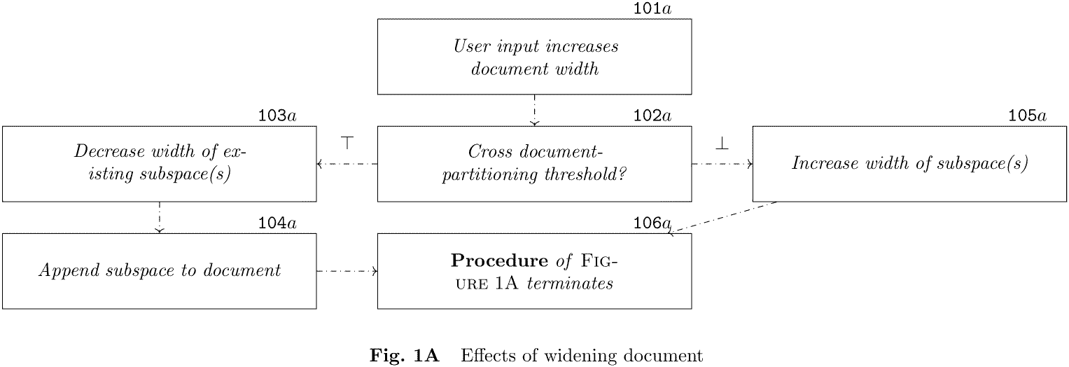

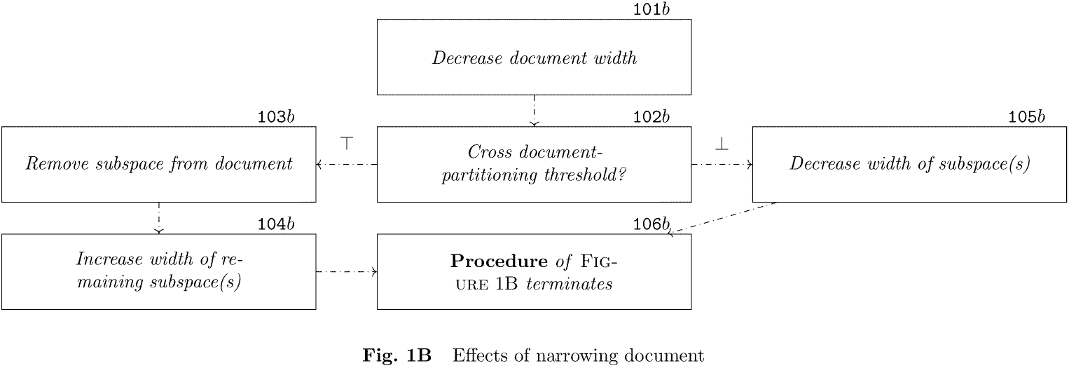

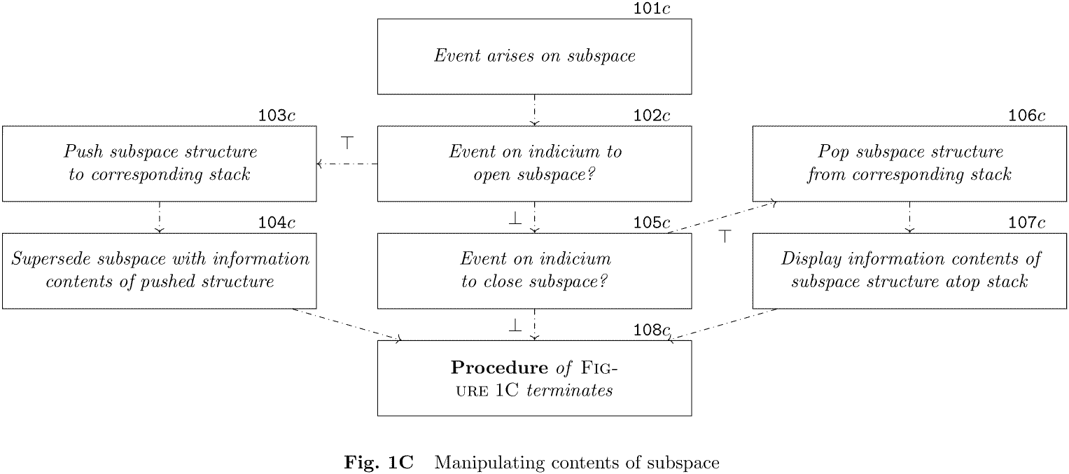

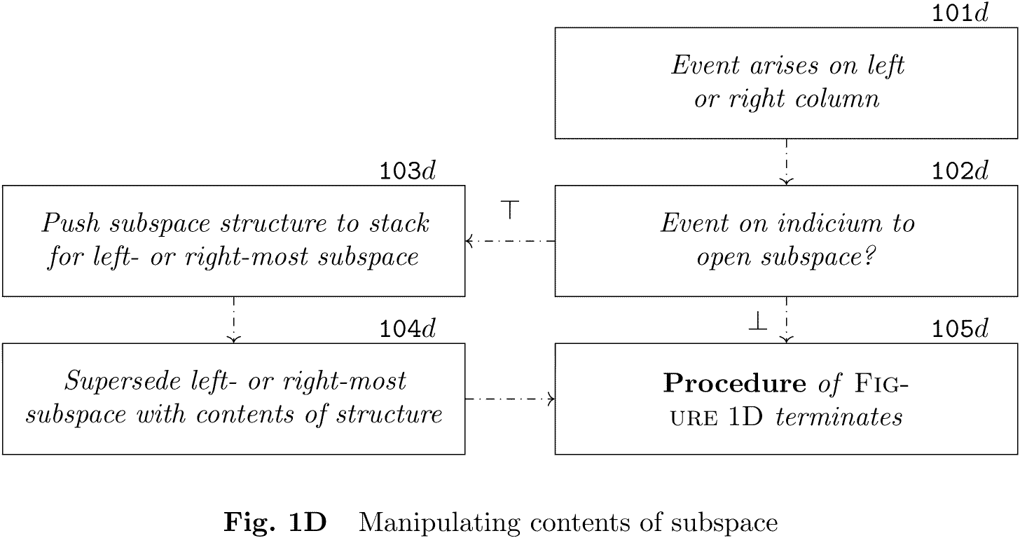

Referring now to FIG. 1A in more detail, an example procedure for manipulating a collection of non-overlapping subspaces housing information (e.g., text, images, video, and/or other data) and nested in a document is illustrated at a high level.

The procedure may be invoked by user input (101a) that increases the width of a document.

If at least one of a plurality of document-partitioning thresholds is crossed as a result (102a –true), the width of one or more subspaces may be decreased, and a new subspace appended to the document. Otherwise (102a –false), the width of one or more subspaces may be increased.

Document-partitioning thresholds may, e.g., be at widths 300u, 600u, 900u, and 1200u for some arbitrary unit u. Then, the document has
one subspace iff its width is 1-300u;
two subspaces iff its width is 301-600u;
three subspaces iff its width is 601-900u; and
four subspaces iff its width is 901-1,200u.

In either case, the subspaces remain non-overlapping and still comprise the entirety of the document, thereby reducing opportunities for wasted space in it.

In state 106a, the process terminates.

The example operations shown in FIG. 1B for decreasing the width of a document are similar.
First, in step 101b, user input decreases the width of a document.
Then, in 102b, it is checked whether at least one document-partitioning threshold is crossed.
If so (102b –true), a subspace is removed from the document in 103b, and the width of one or more of the remaining subspaces is increased in 104b.
If not (102b –false), the width of one or more subspaces is decreased in 105b. In state 106b, the process terminates.

In this example, the above-described invariants, that the subspaces remain non-overlapping and still comprise the entirety of the document, are preserved by these operations.

FIG. 1C illustrates operations for manipulating subspaces nested in a document in more detail. The procedure may be invoked by an event. An event may include, e.g., contact with a device such as a gesture, touchpad movement, or the like.

If the event particularly is on an indicium to open a subspace (102c –true), then a subspace structure is pushed (103c) to its corresponding stack, and the subspace on which the event arose is superseded (104c) with the information contents of the pushed subspace structure. (A subspace structure includes an identifier for a subspace, the information contents of that subspace, and possibly other information.)

Otherwise (102c –false), the process checks (105c) whether the event arose particularly on an indicium to close a subspace. If so (105c –true), the subspace structure is popped (106c) from its corresponding stack, and the information contents of the subspace structure then at the top of the stack is displayed (107c). Otherwise (105c –false), the procedure immediately terminates (108c).

FIG. 1D illustrates operations for manipulating stacks of the subspaces nested in a document in response to user-generated events in different spaces. The procedure is invoked (101d) by an event on a left- or right-side column in a document. If the event particularly is on an indicium to open a subspace (102d –true), then a subspace structure is pushed (103d) to a stack for a left- or right-most “active” subspace, and the left- or right-most “active” subspace is superseded (104d) with the information contents of the pushed subspace structure. (Herein, a subspace and its corresponding stack is called active if and only if the subspace is visible in the document.) Otherwise (102d –false), the procedure immediately terminates (105d).

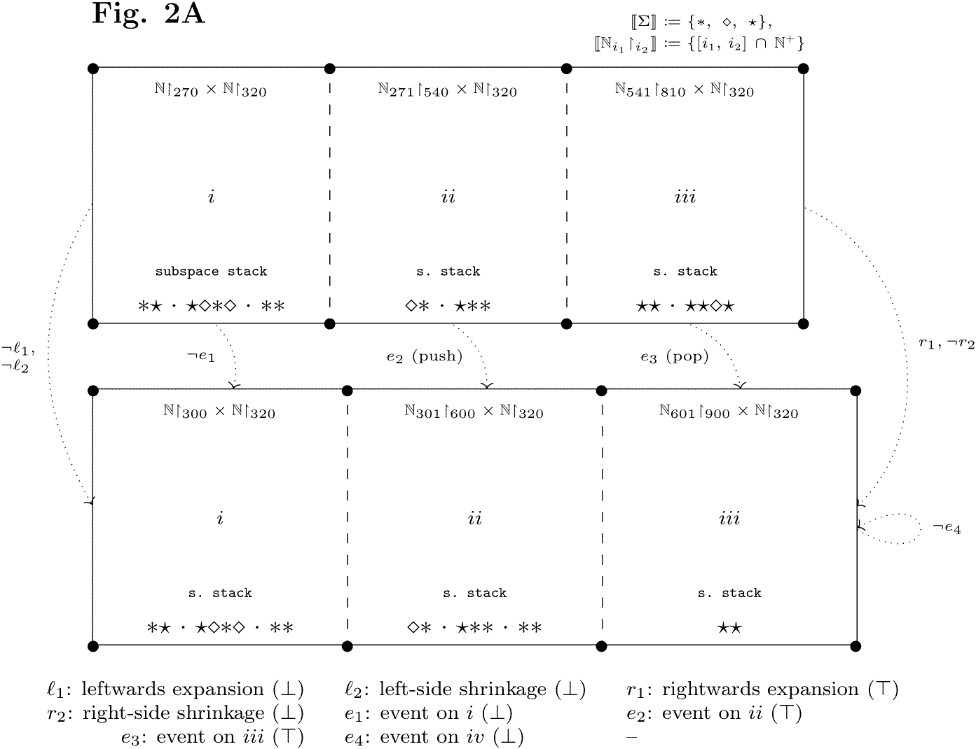

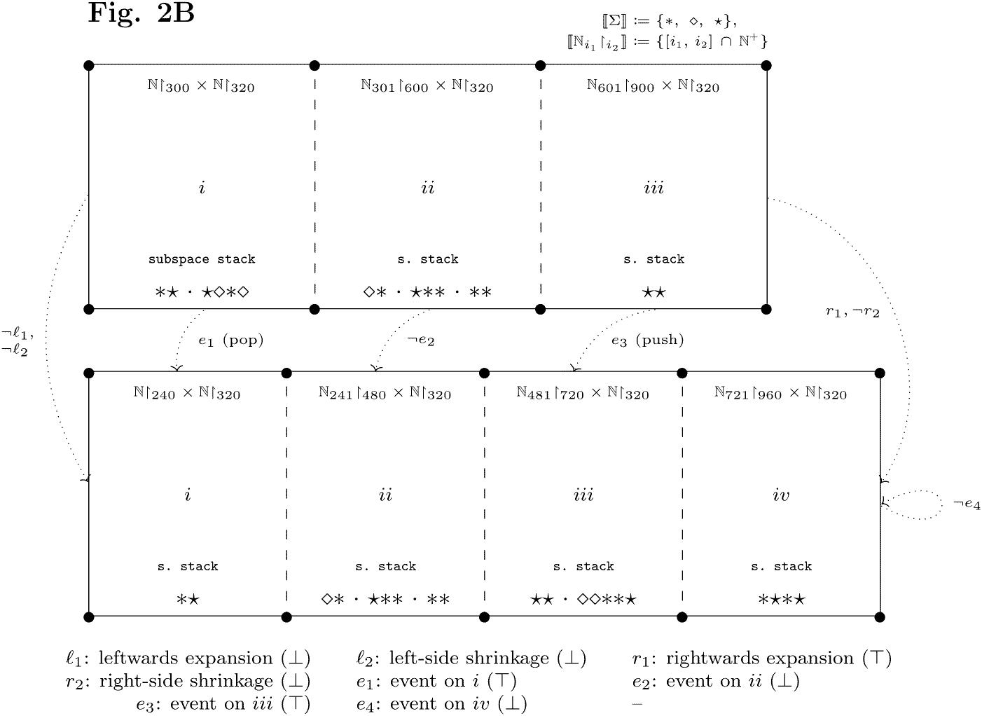

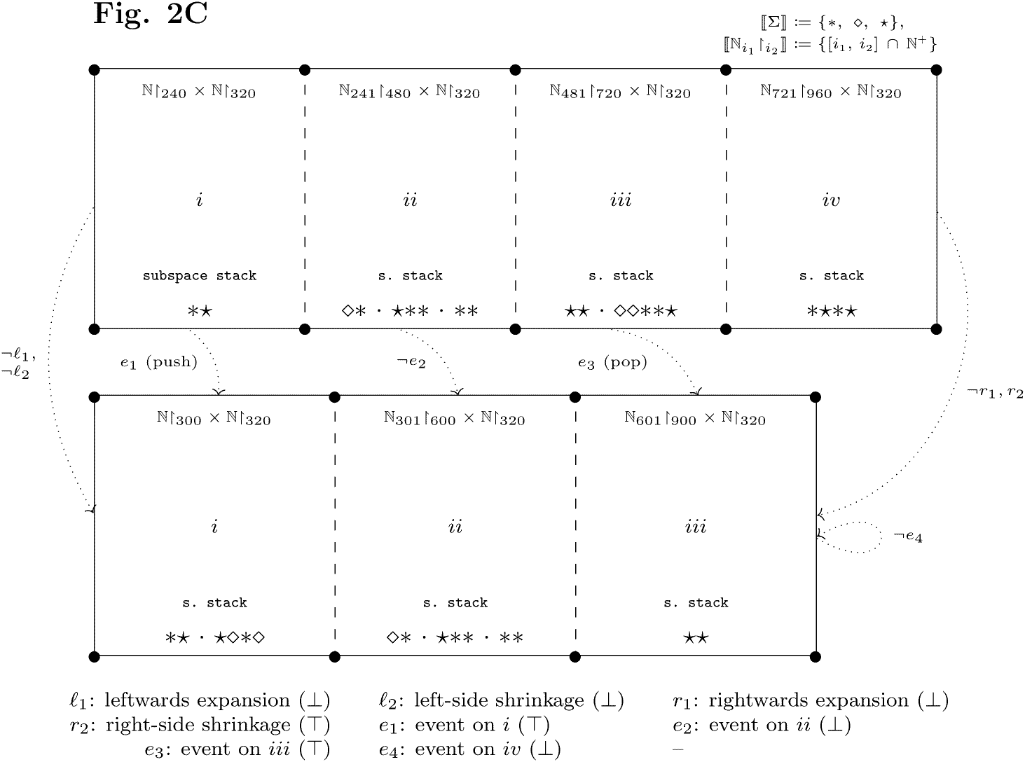

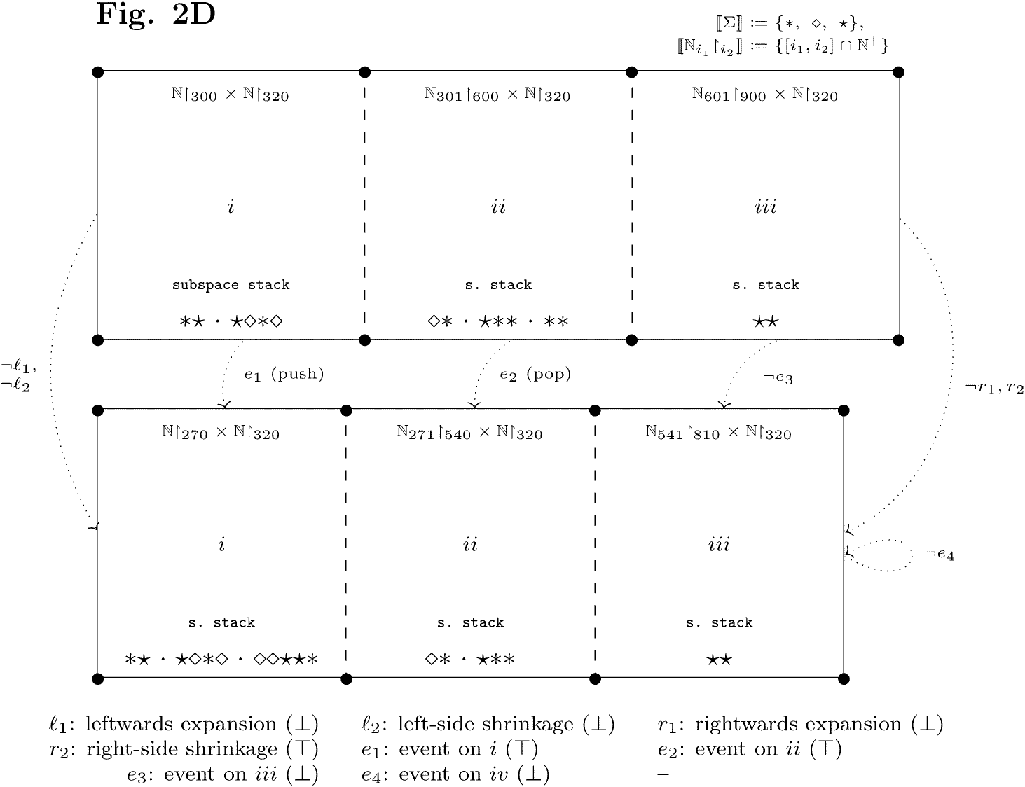

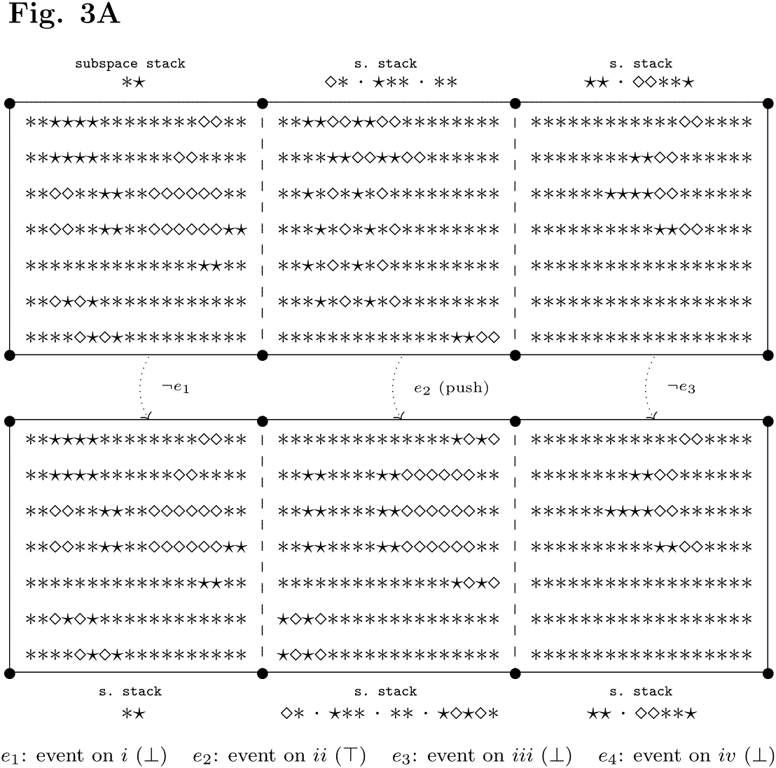

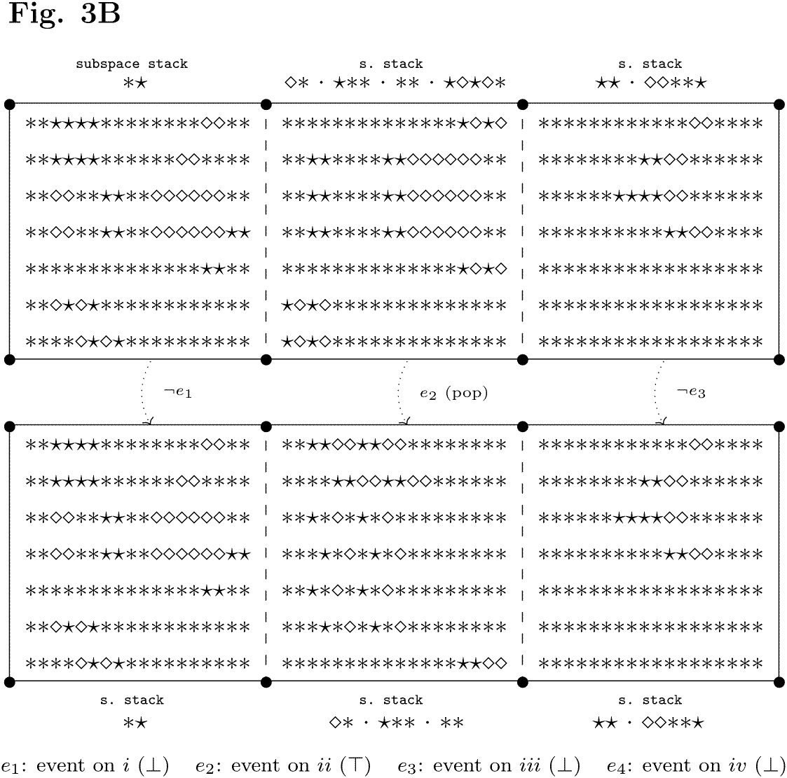

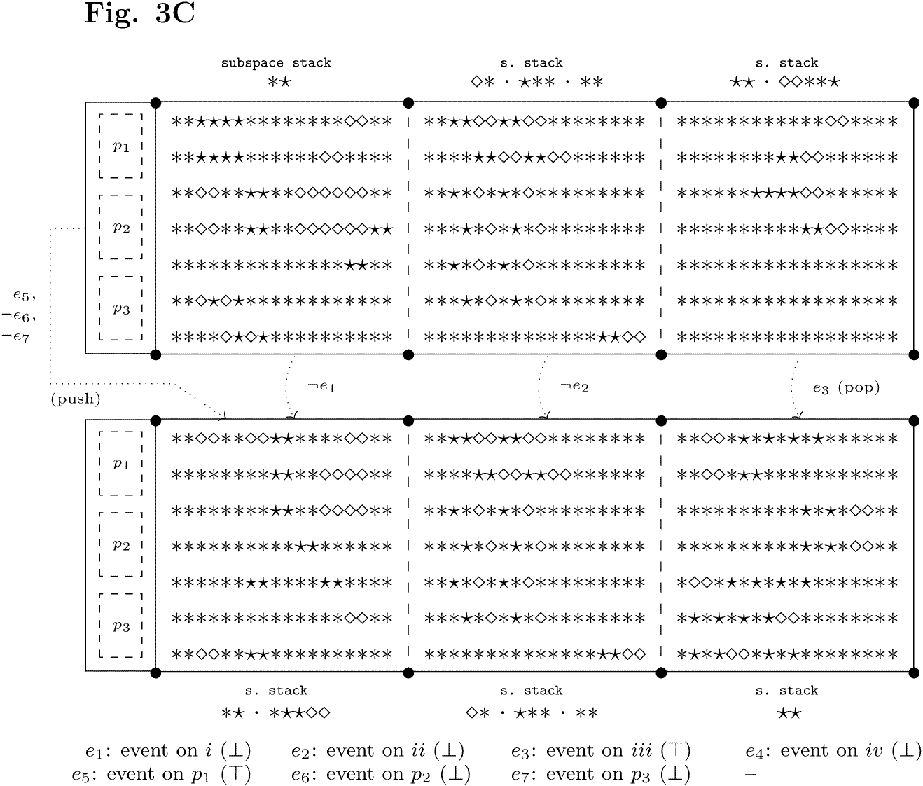

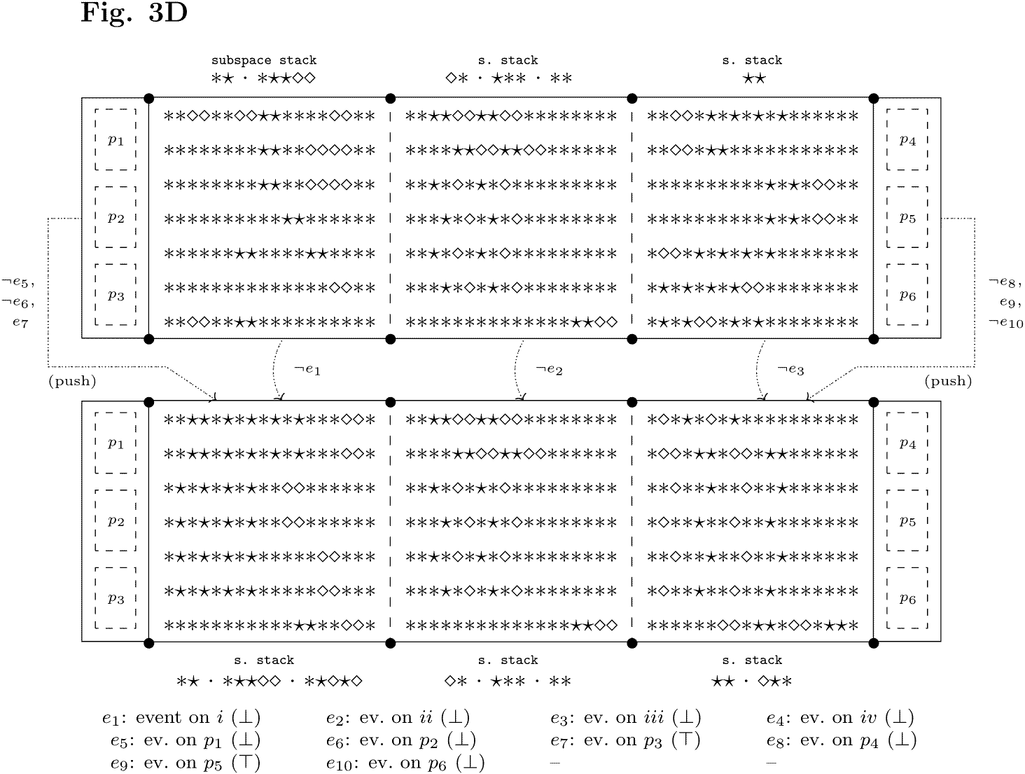

Some conventions used in FIGS. 2A-3D are now introduced. Documents are illustrated as being enclosed in solid lines, and the subspaces nested in them are partitioned about dashed lines. An original document is towards the top of a figure; the same document mutated by user input is presented towards its bottom.

Identifiers for subspaces in FIGS. 2A-3D and the information contents of the subspaces in FIGS. 3A-D are written in a three-symbol alphabet for simplicity. As indicated in the top-right portion of FIGS. 2A-D, the alphabet has as its members an asterisk, a star, and a diamond. The dimensions of subspaces are indicated towards the top of the subspaces in FIGS. 2A-D.

A set-theoretic interpretation for the symbols used to denote the dimensions is given towards the top-right, indicating an inclusive range between positive natural numbers i₁ and i₂.

Identifiers for members of the subspace stacks are delimited by dots. The tops of the stacks are towards the right; the floors of the stacks are towards the left.

Truth values for whether various events arose are indicated beside arrows and towards the bottom of the figures. Arrows are marked with literals that indicate whether an event arose.

Referring now to FIG. 2A in more detail, manipulations to an example document are illustrated. The document is populated with three subspaces i, ii, and iii. Each subspace has one associated stack, and they respectively have three, two, and two members, as indicated by the dots that delimit them. The subspaces are each of size 270u by 320u, again for some arbitrary unit u. Towards the bottom are labels marking atoms stating whether an event arose (┬) or not (┴) - e.g., whether user input expanded the document rightwards (rl-T), a user-generated event arose on subspace i (e1-┴), and so on.

In some examples, the size unit may be a printable or visually rendered character, and in other instances it may be a pixel of visually rendered content. However, it should be understood that in other examples, the size unit may be some other unit suitable for measuring the size or extent of the contents of a document.

In the document, the second subspace initially has its x-coordinates from 271u to 540u and its y-coordinates from 1u to 320u. Then, it has its x-coordinates from 301u to 600u and its y-coordinates still from 1u to 320u. The dimensions for the other subspaces can be interpreted similarly.

User input expands the document rightwards, increasing its size (per state 101a of FIG. 1A) by an amount less than some predetermined amount. A document-partitioning threshold therefore is not crossed (102a –false), and the width of each subspace then increases from 270u to 300u (105a). By increasing the size of each subspace, the subspaces still comprise the entirety of the document and are still visible in their entireties, avoiding unused space. The user generates events in the second and third subspaces (101c), respectively pushing to (102c –true; 103c) and popping from (102c –false; 105c –true; 106c) their stacks. The information contents of the first subspace is preserved; the second subspace introduces new information (its identifier being “**”) (104c); the third subspace revives information presented there earlier (★★◊★ was deleted) (107c).

In FIG. 2B, user input further expands the document rightwards, increasing its width (101a). Because the expansion exceeds a predetermined amount of space, a document-partitioning threshold is crossed (102a –true), so the width of each existing subspace decreases from 300u to 240u (103a), and a fourth subspace is appended to the document (104a). By reducing the size of each subspace and appending a new one in response to the increase in the size of the document, the subspaces retain a manageable amount of space on the part of a user, and superfluous space is avoided. The user generates events in the first and third subspaces (101c), respectively popping from (102c –false; 105c –true; 106c) and pushing to (102c –true; 103c) their stacks. The first subspace revives information presented there earlier (107c); the information contents of the second subspace is preserved; and the third subspace introduces new information (104c).

In FIG. 2C, user input shrinks a document from its right side, decreasing its width (101b). A document-partitioning threshold is crossed (102b –true), so the fourth subspace is removed from the document (103b), and the width of each of the three remaining subspaces increases from 240u to 300u (104b). The user generates events in the first and third subspaces (101c), respectively pushing to (102c –true; 103c) and popping from (102c –false; 105c –true; 106c) their stacks. The first subspace introduces new information (104c); the information contents of the second subspace is preserved; the third subspace revives information presented there earlier (107c).

In FIG. 2D, user input further shrinks a document from its right side, decreasing its width (101b). A document-partitioning threshold is not crossed (102b –false), so the width of each of the three subspaces decreases from 300u to 270u (104b). The user generates events in the first and second subspaces (101c), respectively pushing to (102c –true; 103c) and popping from (102c –false; 105c –true; 106c) their stacks. The first subspace introduces new information (104c); the second subspace revives information presented there earlier (107c); the information contents of the third subspace is preserved.

Referring now to FIG. 3A, a mutation to the information contents of a subspace is illustrated. FIG. 3A shows the content of an example subspace in more detail. In this example, a user generates an event on the second of the three subspaces, causing new information to be outputted in that subspace and the information contents of the subspace to be pushed to its corresponding stack. The new information is represented by a new sequence of symbols from the alphabet discussed earlier. This event did not change the size of the second subspace, so no other modification to the structure of the document arose.

In FIG. 3B, the information originally in the second subspace in 3A is revived: an event arises on the second subspace, popping from its corresponding stack, and the display contents of the subspace structure then at the top of the stack is presented.

Referring now to FIG. 3C in more detail, this example consists of a document with three main subspaces together with a left-side column. A user generates an event on the left-side column (101d). The event is particularly on an indicium marked p1 for opening a subspace (102d –true). Accordingly, a subspace structure is pushed to the left-most stack (103d), and the left-most main subspace (immediately to the right of the left-side column) is superseded with the information contents of the pushed subspace structure (104d). The user also generates an event on the third main subspace (101c), popping from its corresponding stack (102c –false; 105c –true; 106c) and reviving information presented there earlier (107c). The information contents of the second subspace is preserved.

Referring now to FIG. 3D in more detail, three main subspaces together with a left-and a right-side column are shown. A user generates an event on the left-side column (101d). The event is particularly on an indicium marked p3 for opening a subspace (102d –true). Accordingly, a subspace structure is pushed to the left-most “active” stack (103d), and the left-most subspace is superseded with the information contents of the pushed subspace structure (104d). The user also generates an event on the right-side column (101d). The event is particularly on an indicium marked p5 for opening a subspace (102d –true). Accordingly, a subspace structure is pushed to the right-most “active” stack (103d), and the right-most subspace is superseded with the information contents of the pushed subspace structure (104d). The information contents of the second subspace is preserved.

It can now be understood that a document may nest a plurality of stacks of subspaces that are dynamic in size and number. The document may be manipulated in response to user input that modifies its size or that opens or closes a subspace in it. When modified in its size, the document may, e.g., append or remove a subspace and/or change the size of its subspaces given various document-partitioning thresholds. A user-generated event in or beside a subspace may supersede it with new or previous information there. Contents of subspaces previously visited by a user may be stored in a stack, and a user may then be permitted to backtrack to them.

In an example embodiment, the document may be on the World Wide Web, and its contents may be manipulated as described in accordance with HyperText Markup Language.

In a particular embodiment, the document may have horizontally- and/or vertically-partitioned subspaces. In addition to the horizontal partitioning of documents described, the document may vertically partition its subspaces in response to mutations to its height. Such vertically-partitioned subspaces may likewise be dynamic in both size and number, and they may likewise preserve the invariants that they are non-overlapping and that they together comprise the entirety of a document.

### IMPLEMENTATION OPTIONS

It should be understood that the example embodiments described above may be implemented in many different ways. The embodiments may be implemented by data processors located within personal or laptop computers, servers, smartphones, tablets, mobile devices, embedded machines, and other computer systems. In some instances, the various “data processors” may each be implemented by a physical or virtual general-purpose computer having a central processor, memory, disk or other mass storage, communication interface(s), input/output (I/O) device(s), and other peripherals. The general-purpose computer is transformed into the processors and executes the methods described above, for example, by loading software instructions into the computer, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., one or more central processing units, disks, various memories, input/output ports, network ports, etc.) that enables the transfer of information between the elements. One or more central processor units are attached to the system bus and provide for the execution of computer instructions. Also attached to the system bus are typically I/O device interfaces for connecting the disks, memories, and various input and output devices. Network interface(s) allow connections to various other devices attached to a network. One or more memories provide volatile and/or non-volatile storage for computer software instructions and data used to implement an embodiment. Disks or other mass storage provides non-volatile storage for computer-software instructions and data used to implement, for example, the various procedures described herein.

Embodiments may therefore typically be implemented in hardware, custom designed semiconductor logic, Application Specific Integrated Circuits (ASICs), Field Programmable Gate Arrays (FPGAs), firmware, software, or any combination thereof.

In certain embodiments, the procedures, devices, and processes described herein are a computer-program product, including a computer-readable medium (e.g., a removable storage medium such as one or more DVD-ROMs, CD-ROMs, diskettes, tapes, etc.) that provides at least a portion of the software instructions for the system or the method. Such a computer-program product can be installed by any suitable software installation procedure, as is well known in the art. In another embodiment, at least a portion of the software instructions may also be downloaded as application software over a cable, communication network, and/or wireless connection from a server to a smartphone, laptop, personal computer, tablet, or other device.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read-only memory (ROM); random-access memory (RAM); storage including magnetic disk storage media; solid state drives; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc. It also should be understood that the block and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

The above description has particularly shown and described example embodiments. However, it will be understood by those skilled in the art that various changes in form and details may be made therein without departing from the legal scope of this patent as encompassed by the appended claims.

1. An apparatus, comprising:
one or more processors;
a non-transient machine-readable memory with instructions executed by the one or more processors to perform operations to dynamically partition and supersede a plurality of subspaces nested in a document, the operations further comprising:
maintaining a plurality of subspaces nested in a document, the subspaces housing information;
in response to an increase in the size of the document:
either appending a subspace to the document and decreasing the size of one or more of the existing subspaces; or
increasing the size of one or a plurality of the subspaces nested in the document; and
in response to a decrease in the size of the document:
either removing a subspace from the document and increasing the size of one or more of the remaining subspaces; or
decreasing the size of one or a plurality of of the subspaces nested in the document; and
at one of a plurality of the subspaces nested in the document:
in response to the generation of an event on an indicium in the subspace:
superseding the subspace with a subspace housing different information.
